(19) United States
(12) Patent Application Publication
(10) Pub. No.: US 2004/0133885 A1
(43) Pub. Date: Jul. 8, 2004

(54) Method for providing required values

(75) Inventors: Ralf Christian Giering, Hamfelde (DE); Thomas Herbert Kaminski, Hamburg (DE)

Correspondence Address: Dr. Thomas Kaminski, Martinistrasse 21, Hamburg, 20251, DE

(73) Assignee: FastOpt Drs. Ralf Giering und Thomas Kaminski GbR, Hamburg (DE)

(21) Appl. No.: 10/337,791

(22) Filed: Jan. 8, 2003

(51) Int. Cl. G06F 9/45; G06F 9/44

(52) U.S. Cl. 717/140; 717/114; 717/152

(57) ABSTRACT

A method is described for providing required values as needed in a class of computer-program compilers, which transform a first computer-program (source program) into a second computer-program (target program), such that the target program has modified or augmented functionality. The source and target programs may be written in the same or different programming languages. As an example, the compiler may perform automatic differentiation (AD), where the source program evaluates a function and the target program evaluates both the function and its derivative, and both programs are written in a high level programming language such as Fortran. In this example, required values are needed in the target program to evaluate its control flow, index expressions, or local derivative information. Providing required values in an efficient way is essential in AD but constitutes a major complexity for various modes of AD. For typical applications, our method is significantly more efficient than standard approaches.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to the field of computer-program compilers, which transform a first computer-program (source program) into a second computer-program (target program), such that the target program has modified or augmented functionality. The source and target programs may be written in the same or different programming languages. As an example, the compiler may perform automatic differentiation (AD, [Griewank, 1989; Griewank and Corliss, 1991; Berz et al., 1996; Corliss et al., 2002; Griewank, 2000]), i.e. the source program evaluates a function, and the target program evaluates both the function and its derivative, and both programs are written in a high level programming language such as Fortran, C, or Java.

To explain the concept of “required values” [Giering and Kaminski, 1998], we take AD as an example (see also Giering and Kaminski [2002]). For a differentiable function represented by a source program, AD is the process of constructing a target program that represents the function's derivative (Jacobian matrix). The target program applies the chain rule, i.e. it evaluates a product of the local Jacobian matrices representing the derivatives of the individual steps in the source program. If the number of the function's output (dependent) variables exceeds the number of input (independent) variables, it is usually favorable to have the derivative program operate in the forward mode of AD (tangent linear code), i.e. to evaluate said product of local Jacobian matrices in the same order as the source program. If the number of the function's input variables exceeds the number of output variables, it is usually favorable to have the derivative program operate in the reverse mode of AD (adjoint code), i.e. to evaluate said product of local Jacobian matrices in the order reverse to that of the source program. If, in forward mode, there is more than one independent variable, one distinguishes between a scalar mode and a vector mode. Scalar mode refers to evaluation of the product of the Jacobian times one vector. Vector mode refers to the simultaneous evaluation of the product of the Jacobian times multiple vectors, which includes evaluation of the full Jacobian. In reverse mode, scalar and vector modes are defined analogously. If the target program evaluates both the function value and the value of its derivative, we call this regular mode, as opposed to the pure mode, where the target program evaluates only the derivative.

Required values are values computed by the source program, which are used in the target program. Variables holding required values are called required variables. In the case of AD required values are needed in the target program to evaluate the target program's control flow, index expressions, or local Jacobian's entries [Fauré and Naumann, 2002]. In the case of Automatic Sparsity Detection (ASD), i.e. determination of the sparsity pattern [Griewank, 2000] of the source program's Jacobian matrix, required values are needed in the target program to evaluate the target program's control flow, index expressions, or the local Jacobian's sparsity pattern. Providing required values in an efficient way is essential in AD and ASD (and further transformations) but constitutes a major complexity for various modes of these transformations. Standard strategies for providing required values are

1. recomputing all required values within the target program: recompute-all (RA) strategy

2. storing for each variable modified in the source program the variable's value prior to modification followed by retrieving the value in the target program before it is required: store-all-modified-variables (SA) strategy.

We use the following example taken from Giering and Kaminski [2002] to explain prior art: APPENDIX A shows a program in the programming language Fortran 77, which defines a function with input (independent variable) x and output (dependent variable) z. The function code consists of a single block of four assignments, one of which (statement 3) is overwriting the variable y, which was defined previously (statement 1). We describe the above strategies for providing required variables by means of the respective adjoint codes corresponding to the source program in APPENDIX A. We focus on the recomputations; The structure of the adjoint code without recomputations is discussed in detail by Giering and Kaminski [1998]. The program in APPENDIX B employs the SA strategy. The derivative statements (denoted by a leading A) reference both adjoint variables (marked by the prefix ad) and required variables (same names as in function code). In the so-called split mode [Griewank, 2000] during a preceding forward sweep through the block the value of every variable is saved to an auxiliary variable (S1, . . . , S4) before a new value is assigned. During the following reverse sweep through the adjoints of the individual statements of the block, the value previously saved in front of a statement is retrieved in front of the corresponding adjoint statement (R4, . . . , R1). This strategy ensures that all required variables have their correct values. Instead of storing in memory (as shown), hard disk or other storage devices could be used as well. The SA strategy is implemented in the AD-tool Odyssee [Rostaing et al., 1993] on the level of blocks defined by subroutine bodies (see also Fauré and Naumann [2002]).

In the previous example, several save/retrieve pairs (R1, R2, and R4) are unnecessary, because the retrieved values are not required. The adjoint code is inefficient in that it uses more memory and more CPU time than necessary. For many large-scale applications the SA strategy is infeasible, since it exceeds available disk/memory resources. The research of Fauré and Naumann [2002] is directed towards a reduction of unnecessary save/retrieve pairs (“To be recorded analysis”).

The program in APPENDIX C employs the RA strategy. Instead of inserting save/retrieve pairs, code for recomputing required values is inserted: Every adjoint statement is preceded by the fraction of the block that precedes the corresponding statement. The RA strategy is implemented in the AD-tool AMC [Giering, 1996]. The RA strategy results in inefficient code since some of the recomputations are unnecessary. In the example, E3.2 and E.2.1 are not needed, because variable w is not referenced thereafter and variable y already has its required value. The AD-tool TAMC [Giering, 1999] attempts to generate a minimum of recomputations. The TAMC procedure is suboptimal in that it generates both unnecessary recomputations or wrong code [Giering and Kaminski, 2002]. Both are serious drawbacks.

The patent of Bittner et al. [2001] covers a method which combines the compiler capabilities of program augmentation (such as AD) and optimization. It does not address the issue of providing required values.

### REFERENCES

Berz, M., C. Bischof, G. Corliss, and A. Griewank (Eds.), Computational Differentiation: Techniques, Applications, and Tools, SIAM, Philadelphia, 1996.

Bittner, C. J., B. M. Grossman, R. D. Jenks, S. M. Watt, and R. Q. Williams, Computer-program compilers comprising a program augmentation capability, United States Patent, 2001.

Corliss, G., C. Faure, A. Griewank, L. Hascoet, and U. Naumann (Eds.), Automatic Differentiation of Algorithms: From Simulation to Optimization, Springer, New York, 2002.

Fauré, C., and U. Naumann, The trajectory problem in AD, in Automatic Differentiation of Algorithms: From Simulation to Optimization, edited by G. Corliss, A. Griewank, C. Faure, L. Hascoet, and U. Naumann, pp. 111-222, Springer Verlag, Heidelberg, Germany, 2002.

Giering, R., AMC: Ein Werkzeug zum automatischen Differenzieren von Fortran-Programmen, in Forschung und wissenschaftliches Rechnen, Beitrage zum Heinz-Billing-Preis 1995, edited by T. Plesser and P. Wittenburg, vol. 42, pp. 11-27, Gesellschaft fir wissenschaftliche Datenverarbeitung mbH, Göttingen, Germany, 1996.

Giering, R., Tangent linear and Adjoint Model Compiler, Users manual 1.4, 1999, unpublished, available at http://www.autodiff.com/tamc.

Giering, R., and T. Kaminski, Recipes for Adjoint Code Construction, ACM Trans. Math. Software, 24, 437-474, 1998.

Giering, R., and T. Kaminski, Generating recomputations in reverse mode AD, in Automatic Differentiation of Algorithms: From Simulation to Optimization, edited by G. Corliss, A. Griewank, C. Fauré, L. Hascoet, and U. Naumann, chap. 33, pp. 283-291, Springer Verlag, Heidelberg, Germany, 2002.

Griewank, A., On automatic differentiation, in Mathematical Programming: Recent Developments and Applications, edited by M. Iri and K. Tanabe, pp. 83-108, Kluwer Academic Publishers, Dordrecht, 1989.

Griewank, A., Evaluating Derivatives: Principles and Techniques of Algorithmic Differentiation, no. 19 in Frontiers in Appl. Math., SIAM, Philadelphia, Penn., 2000.

Griewank, A., and G. Corliss (Eds.), Automatic Differentiation of Algorithms, SIAM, Philadelphia, 1991. Rostaing, N., S. Dalmas, and A. Galligo, Automatic differentiation in Odyssée, Tellus, 45A, 558-568, 1993.

### BRIEF SUMMARY OF THE INVENTION

Our invention consists in a method for efficiently providing required values. The method applies a combination of a recomputation strategy and a storing/reading strategy for values of required variables and intermediate variables from which required values can be computed. In our method, the generation of recomputations is such that unnecessary recomputations are avoided.

### BRIEF DESCRIPTION OF THE SEVERAL VIEWS OF THE DRAWING

Not applicable.

### DETAILED DESCRIPTION OF THE INVENTION

Our invention consists in a method for efficiently providing required values. The method applies a combination of a recomputation scheme and a storing/reading scheme for values of required variables and intermediate variables from which required values can be computed.

Our method is based on the definition of a set of values which are to be stored/retrieved. A corresponding store/retrieve-scheme is generated. Based on all then available values, a recomputation scheme is generated, which encompasses the remaining recomputations which are necessary to provide all required values. Our method offers two ways of defining the set of values which are stored/retrieved. They can be defined by the user, e.g. through directives in the code of the source program, or they can be determined algorithmically, e.g. such that a combination of the required CPU and disk/memory resources are minimized.

In our method, the generation of recomputations avoids unnecessary recomputations by including:

1. an analysis of access patterns of all data types that hold more than a scalar real number (e.g. arrays (Fortran), structures (C), or derived types (Fortran-90)),

2. a method of cloning and slicing of subprograms, and

3. a pointer analysis.

We use the following examples based on the scalar valued function of APPENDIX A with the same naming conventions to explain these three points. APPENDIX D shows a block in a source program, which is similar to APPENDIX A. The only difference is that the scalar y is now replaced by an array. Our method's analysis of the array access pattern is essential to notice that in the adjoint code shown in APPENDIX E, the statement E4.3 is not overwriting the value of y(1). A method which lacks this analysis must base the code generation on prior assumptions, which can be either conservative or risky. The first choice results in code which may be inefficient and the latter choice results in code which may be wrong. TAMC-generated code suffers from both problems. For the program in APPENDIX D TAMC generates inefficient code. Another example for the benefit of the analysis of array access patterns is shown in source program APPENDIX F and the target program APPENDIX G. For this example, TAMC generates wrong adjoint code.

APPENDIX H shows a block in a source program, which is similar to APPENDIX A. The only difference is that the first two assignments are now moved to a subroutine. Our method generates the adjoint code shown in APPENDIX I. Our method's capability of cloning and slicing subroutines is essential to allow generating the call of subslice as recomputation E3.1, in order to provide the required value of y to A3. subslice is a clone of sub, which has been sliced, i.e. the parts of sub that are not necessary in the present recomputation context have been removed. A method which lacks this capability must include a call of the full subroutine sub, which results in inefficient adjoint code. TAMC-generated code suffers from this problem.

APPENDIX J shows a block in a C-code source program, which is similar to APPENDIX A. The only difference is that there are two pointers p, q which point to y and that the two assignments to y are realized via the pointers. Our method's pointer-analysis is essential to notice that in the adjoint code shown in APPENDIX K, the statement E4.3 is overwriting the value of y. Hence, E3.1 needs to be inserted in order to provide the correct value of y. A method which lacks this analysis must base the code generation on prior assumptions, which can be either conservative or risky. The first choice results in code which may be inefficient and the latter choice results in code which may be wrong. TAMC does not handle pointers at all.

What the examples illustrate for the scalar mode applies in a similar way in vector mode, or for target programs which evaluate higher-order derivatives or Taylor series coefficients. Typical applications other than AD are ASD or interval arithmetics (see e.g. [Berz et al., 1996; Corliss et al., 2002]).

APPENDIX A: A simple example of a function with input (independent variable) x and output (dependent variable) z.

subroutine func (x,z)

real x,y,w,z

y=2*x

w=cos(y)

y=sin(y)

z=y*w

end

APPENDIX B: Adjoint of the block of APPENDIX A generated by the SA strategy. a+=b is a shorthand notation for a=a+b.

S1 s1=y

1 y=2*x

S2 s2=w

2 w=cos(y)

S3 s3=y

3 y=sin(y)

S4 s4=z

4 z=y*w

R4 z=s4

A4 adw+=y*adz

ady+=w*adz

adz=0

R3 y=s3

A3 ady=cos(y)*ady

R2 w=s2

A2 ady+=−sin(y)*adw

adw=0

R1 y=s1

A1 adx+=2*ady

ady=0

APPENDIX C: Adjoint of the block of APPENDIX A generated by the RA strategy. a+=b is a shorthand notation for a=a+b.

E4.1 y=2*x

E4.2 w=cos(y)

E4.3 y=sin(y)

A4 adw+=y*adz

ady+=w*adz

adz=0

E3.1 y=2*x

E3.2 w=cos(y)

A3 ady=cos(y)*ady

E2.1 y=2*x

A2 ady+=−sin(y)*adw

adw=0

A1 adx+=2*ady

ady=0

APPENDIX D: A simple Fortran-example illustrating the benefit of an array region analysis.

subroutine func2 (x,z)

real x,y(2),w,z

1 y(1)=2*x

2 w=cos(y(1))

3 y(2)=sin(y(1))

4 z=y(2)*w

end

APPENDIX E: Adjoint of the block of APPENDIX D generated with an analysis of array access patterns. a+=b is a shorthand notation for a=a+b.

E4.1 y(1)=2*x

E4.2 w=cos(y(1))

E4.3 y(2)=sin(y(1))

A4 adw+=y(2)*adz

ady(2)+=w*adz

adz=0

A3 ady(1)+=cos(y(1))*ady(2)

ady(2)=0.

A2 ady(1)+=−sin(y(1))*adw

adw=0

A1 adx+=2*ady(1)

ady(1)=0

APPENDIX F: A second simple Fortran-example illustrating the benefit of an array region analysis.

subroutine func3 (x,z)

real x,y(2),w,z

1 y(1)=2*x;

2 call part(x, y)

3 w=cos(y(1));

4 z=y(2)*w

end

subroutine part(x, y)

real:: x, y(2)

y(2)=sin(2*x)

end

APPENDIX G: Adjoint of the block of APPENDIX F generated with an analysis of array access patterns. a+=b is a shorthand notation for a=a+b.

E4.1 y(1)=2*x

E4.2 call part(x,y)

E4.3 w=cos(y(1))

A4 adw+=y(2)*adz

ady(2)+=w*adz

adz=0

A3 ady(1)+=−adw*sin(y(1))

adw=0.

A2 call adpart(x,adx,ady)

A1 adx+=2*ady(1)

ady(1)=0

subroutine adpart(x, adx, ady)

adx=adx+2*ady(2)*cos(2*x)

ady(2)=0.

end

APPENDIX H: A simple Fortran-example illustrating the benefit of the capability of cloning and slicing of subprograms.

subroutine func4 (x,z)

real x,y,w,z

1 call sub(x, y, w)

3 y=sin(y)

4 z=y*w

end

subroutine sub(x, y, w)

real x, y, w

y=2*x

w=cos(y)

end

APPENDIX I: Adjoint of the block of APPENDIX D generated with the capability of cloning and slicing of subprograms. a+=b is a shorthand notation for a=a+b

E4.1 call sub(x, y, w)

E4.3 y=sin(y)

A4 adw+=y*adz

ady+=w*adz

adz=0

E3.1 call subslice(x, y)

A3 ady+=cos(y)*ady

ady=0.

A1 call adsub(x, adx, ady, adw)

subroutine subslice(x, y)

real x, y

y=2*x

end

subroutine adsub(x, adx, ady, adw)

real x, adx, ady, adw

y=2*x

ady=ady−adw*sin(y)

adw=0.

adx=adx+2*ady

ady=0.

end

APPENDIX J: A simple example of a C-code block illustrating the benefit of a pointer analysis.

double x,w,y,z,*p,*q;

q=p;

1 *p=2*x;

2 w=cos(*p);

3 *q=sin(*p);

4 z=(*q)*w;

APPENDIX K: Adjoint of the block of APPENDIX J generated with a pointer analysis.

double x,w,y,z,*p,*q;

double adx,adw,ady,adz,*adp,*adq;

p=&y

q=p;

E4.1*p=2*x;

E4.2 w=cos(*p);

E4.3*q=sin(*p);

adp=&ady;

adq=adp;

ady=0.;

adw=0.;

A4 adw+=(*q)*adz;

*adq+=w*adz;

adz=0.;

E3.1*p=2*x;

A3*adp=cos(*p)*(*adq);

A2*adp+=−sin(*p)*adw;

adw=0.;

A1 adx+=2*(*adp);

ady=0;

We claim:

1. A method for providing required values in compiler transformations, said method applying
(a) a recomputation scheme that avoids unnecessary recomputations by including:
i. either an analysis of access patterns of all data types that hold more than a scalar real number (e.g. arrays (Fortran), structures (C), or derived types (Fortran-90)),
ii. a method of cloning and slicing of subprograms, or
iii. a pointer analysis,
or any combination of these three procedures,
(b) or a combination of said recomputation scheme and a storing/reading scheme for required values and intermediate values from which required values can be computed, wherein said combination of schemes may either be determined by the user, e.g. via directives in the code of the source program, or be determined algorithmically, e.g. such that a combination of the required CPU and disk/memory resources are minimized.

2. The method according to claim 1, wherein the compiler transformation is automatic differentiation
(a) in forward or reverse mode, and
(b) in scalar or vector mode, and
(c) in regular or pure mode, and
(d) is evaluating first-order derivatives, higher-order derivatives, or Taylor series coefficients.

3. The method according to claim 1, wherein the compiler transformation is automatic sparsity detection in
(a) in forward or reverse mode, and
(b) in scalar or vector mode.

4. The method according to claim 1, wherein the compiler transformation is interval arithmetic.
